(19) United States
(12) Patent Application Publication
(10) Pub. No.: US 2024/0322477 A1
(43) Pub. Date: Sep. 26, 2024

(54) Crown Spring with Alternating Spring Blade Design

(71) Applicants: TE Connectivity Nederland BV, s'Hertogenbosch (NL); TE Connectivity India Private Limited, Bangalore (IN)

(72) Inventors: Freddy Jean Philip Dendas, S'Hertogenbosch (NL); Kesavamurthy Kavaramalai, Bangalore (IN)

(73) Assignees: TE Connectivity Nederland BV, s'Hertogenbosch (NL); TE Connectivity India Private Limited, Bangalore (IN)

(21) Appl. No.: 18/611,895

(22) Filed: Mar. 21, 2024

(30) Foreign Application Priority Data
Mar. 21, 2023 (EP) 23163201.9

(51) Int. Cl. H01R 13/187; F16F 1/02

(52) U.S. Cl. CPC H01R 13/187; F16F 1/028

(57) ABSTRACT

A crown spring includes a plurality of spring blades that are radially deflectable, a proximal ring member connecting proximal ends of the spring blades, and a distal ring member connecting distal ends of the spring blades. Each of the spring blades has only one contact section contacting a pin contact inserted into the crown spring in the axial direction. The contact section is disposed at a radially most inward portion of the spring blade. The contact sections of the spring blades are arranged in a pair of annular zones that extend around an axial direction and are spaced apart from each other in the axial direction. The contact sections in each of the annular zones are located in a same radial plane perpendicular to the axial direction.

### CROSS-REFERENCE TO RELATED APPLICATIONS

This application claims the benefit of the filing date under 35 U.S.C. § 119(a)-(d) of European Patent Application No. 23163201.9, filed on Mar. 21, 2023.

### FIELD OF THE INVENTION

The invention relates to a crown spring for receiving a pin contact in an axial direction and to an electric connector comprising such a crown spring.

### BACKGROUND

Crown springs are used for example in electrical connectors for connecting a pin contact to a socket. In general, it is desired that the crown spring fixates the contact pin inside the socket and ensures a low contact resistance between at least one of the contact pin and the crown spring and the crown spring and the socket. For this purpose, the crown spring must provide a high contact normal force. The contact normal force is usually created by spring blades, which are deflected in a radial outward direction during axial insertion of the pin contact into the crown spring.

Typically, a high contact normal force is accompanied by a large insertion force that must be overcome during insertion of the pin into the socket. The insertion force, however, must not be too high, to allow insertion of the pin into the contact in the field even under adverse condition, e.g. in an ergonomically adverse position.

### SUMMARY

A crown spring includes a plurality of spring blades that are radially deflectable, a proximal ring member connecting proximal ends of the spring blades, and a distal ring member connecting distal ends of the spring blades. Each of the spring blades has only one contact section contacting a pin contact inserted into the crown spring in the axial direction. The contact section is disposed at a radially most inward portion of the spring blade. The contact sections of the spring blades are arranged in a pair of annular zones that extend around an axial direction and are spaced apart from each other in the axial direction. The contact sections in each of the annular zones are located in a same radial plane perpendicular to the axial direction.

### BRIEF DESCRIPTION OF THE DRAWINGS

Features of the present invention will become more apparent by describing in detail exemplary embodiments thereof with reference to the accompanying drawings, in which:

FIG. 1 is a schematic side view of a crown spring according to a first embodiment of the invention;

FIG. 2 is a schematic sectional side view of an electric connector according to a further embodiment of the invention including a crown spring; and

FIG. 3 is a graph of force and distance of a crown spring according to one of the embodiments of the invention.

### DETAILED DESCRIPTION OF THE EMBODIMENTS

In the following, an embodiment of the invention is exemplarily described with reference to the drawings. In the drawings, the same reference numerals are used for elements that correspond to each other with respect to at least one of structure and function. A feature may be omitted from the described embodiment if the technical effect of this particular feature is not needed in a particular application. Conversely, a feature may be added to a described embodiment if, for a specific application, the technical effect of this particular feature is beneficial.

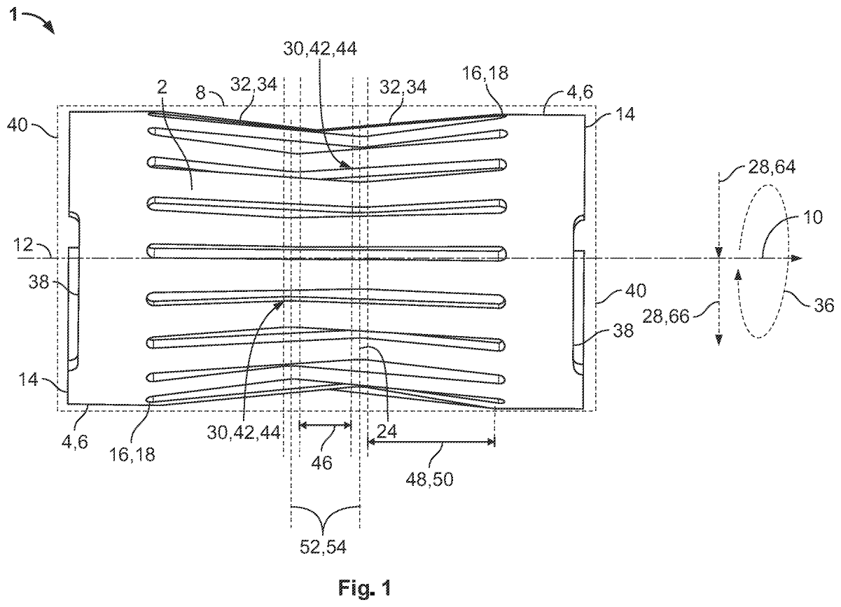

First, the structure of a crown spring 1 is described with reference to FIG. 1. As shown, the crown spring 1 comprises a plurality of radially deflectable spring blades 2, a proximal ring member 4, and a distal ring member 6. The crown spring 1 has the shape of a cylinder 8, which extends in an axial direction 10. A central axis 12 of the cylinder 8 extends along the axial direction 10. The cylinder 8 is open on a pair of end faces 14.

Each spring blade 2, as shown in FIG. 1, has a proximal end 16 and a distal end 18 and extends from the proximal ring member 4 to the distal ring member 6. The spring blades 2 may be oriented parallel to each other and to the axial direction 10.

Each of the spring blades 2 has only one contact section 24, which is configured to contact a pin contact 26. The contact section 24 is located at the radially most inward portion of each of the spring blades 2. In particular, the contact section 24 is the portion of each spring blade 2, which, in the radial direction 28, has the shortest distance to the central axis 12. The radial direction 28 extends perpendicular to the axial direction 10. In an embodiment, the spring blades 2 are configured to be elastically deflectable in the radial direction 28. The spring blades 2 may also be referred to as spring lamellas or spring fingers. In an embodiment, those spring blades 2 are formed identically of which the contact sections 24 are located in the same annular zone 30.

To ensure a good electric contact between the contact section 24 and the pin contact 26, the contact section 24 may have a concave shape, the concave shape having an apex that points inward in the radial direction 28. In an embodiment, all contact sections 24 may be located at the same radial distance from the central axis 12. This is advantageous for achieving an even mechanical load distribution along the circumferential direction of the pin contact 26, leading to less material wear and better centering during axial insertion of a pin contact 26 into the crown spring 1.

As shown in FIG. 1, each spring blade 2 may have a proximal straight section 32 and a distal straight section 34. The proximal straight section 32 extends linearly from the proximal ring member 4 to the contact section 24 of the spring blade 2 and the distal straight section 34 extends linearly from the distal ring member 6 to the contact section 24. The proximal straight section 32 and the distal straight section 34 thus may have no curvature when undeflected in an initial state of the crown spring 1.

The contact section 24 itself may be bent or folded. A crown spring 1 according to this embodiment can be manufactured in a cost-saving way, as the spring blades 2 can be formed from a straight semi-finished product with little effort.

The ring members 4, 6 optionally may have the same diameter. The diameters of the ring members 4, 6 are regarded as being the same if they do not deviate from each other by more than 20%. Both the proximal ring member 4 and the distal ring member 6 extend in a circumferential direction 36, which extends around the axial direction 10. The proximal ring member 4 connects the proximal ends 16 of neighboring spring blades 2, and the distal ring member 6 connects the distal ends 18 of neighboring spring blades 2. In particular, the ring members 4, 6 may be monolithically formed with or integrally connected to the ends of the spring blades 2, or joined via material-locking, friction-locking or form-locking.

The crown spring 1 may be essentially cylindrical which is advantageous for centering the crown spring 1 inside a socket terminal of a likewise cylindrical form. In particular, the spring blades 2 and ring members 4, 6 may form a cage surrounding an essentially cylindrical volume, the cylindrical volume being configured to receive the pin contact 26 while deflecting the spring blades 2 in the radial outward direction. This improves centering of the pin contact 26 inside the crown spring 1.

At least one of the proximal ring member 4 and the distal ring member 6 may comprise at least one recess 38 being located at an axial end 40 of the ring member 4, 6. Both axial ends 40 face away from the spring blades 2. The at least one recess 38 is set back in the axial direction 10 towards the spring blades 2. The at least one recess 38 extends in the circumferential direction 36. In particular, the crown spring 1 may comprise two recesses 38 diametrically opposed to one another with respect to the axial direction 10.

The at least one recess 38 may extend in the circumferential direction 36 along less than 75% of the perimeter of the respective axial end of the ring member 4, 6. The crown spring 1 has the advantage that a tool can engage with the recess 38, e.g. for rotating the crown spring 1 inside a socket. This simplifies the assembly and the positioning of the crown spring 1. In addition, the provision of a recess 38 removes material surpluses and burrs that may arise from the production of the crown spring 1. This improves the electrical and mechanical contact and facilitates handling. Optionally, the at least one recess 38 may extend in the circumferential direction 36 along less than 50%, less than 30%, or more than 20% of the perimeter of the ring member 4, 6. This allows a sufficiently large opening for a tool without endangering the structural mechanical load capacity of the crown spring 1.

A contact section 24 of a spring blade 2 is arranged either in a proximal annular zone 42 or in a distal annular zone 44. In particular, both the proximal annular zone 42 and the distal annular zone 44 may comprise the same amount of contact sections 24. In an embodiment, the contact sections 24 are located at the same radial distance from the central axis 12, wherein the central axis 12 extends in the axial direction 10. In an embodiment, the contact section 24 of each of the spring blades 2 may be located at the portion of the spring blade 2 that is closest to the central axis 12.

The contact sections 24 of neighbored spring blades 2 may be arranged in two different annular zones 30, as shown in FIG. 1. A spring blade 2, of which the contact section 24 is arranged in the proximal annular zone 42, may neighbor two spring blades 2, of which the contact sections 24 are arranged in the distal annular zone 44. Thus, the contact sections 24 of successive contact blades 24 in the circumferential direction 36 are alternatingly arranged in the proximal annular zone 42 and the distal annular zone 44.

The annular zones 30, 42, 43 extend in the circumferential direction 36. Further, the annular zones 30, 42, 44 may be spaced apart from each other in the axial direction 10 by a first axial offset 46. A second axial offset 48 between the distal annular zone 44 and the distal ring member 6 and a third axial offset 50 between the proximal annular zone 42 and the proximal ring member 4 depend on the embodiment of the invention. As regards the crown spring 1 shown in FIG. 1, the axial offsets 46, 48, 50 are identical.

In one embodiment of the crown spring 1, the distance in the axial direction 10 between the distal annular zone 44 and the distal ring member 6 may correspond to the distance in the axial direction 10 between the distal annular zone 44 and the proximal annular zone 42. This is useful in applications where the mounting direction of the crown spring 1 is significant, e.g. during assembling with a socket terminal. Such an embodiment allows to distinguish the ends of the crown spring 1. In general, the crown spring 1 does not need to be mirror-symmetric with respect to a plane that is perpendicular to a longitudinal or axial direction, or the central axis 12, of the crown spring 1.

The contact sections 24 that are located in the same annular zone 30, 42, 44 may be located in the same radial plane 52, 54, respectively. The radial planes 52, 54 are oriented perpendicular to the axial direction 10. For example, the contact sections 24 that are arranged in the distal annular zone 44 may be located in a first radial plane 52 and the contact sections 24 that are arranged in the proximal annular zone 42 may be located in a second radial plane 54. The radial planes 52, 54 are parallel to each and be perpendicular to the axial direction 10.

The crown spring 1 may be formed from a stamped and bent metal sheet. Thereby, the crown spring 1 can be produced with lower costs, particularly due to an automated production.

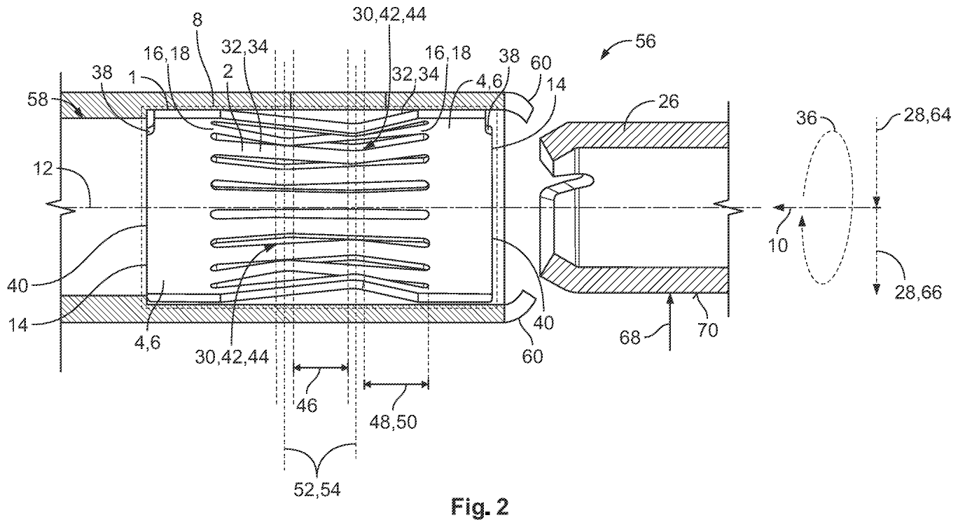

In the following, the structure and functionality of an exemplary electric connector 56 comprising the crown spring 1 of FIG. 1 is described with reference to FIG. 2. As shown in FIG. 2, the electric connector 56 comprises a socket 58, into which the crown spring 1 is inserted. A mating connector that is to be configured to be connected to the electric connector 56 may comprise a pin contact 26.

The proximal ring member 4 and the distal ring member 6 are arranged coaxially with the socket 58. Both the proximal ring member 4 and the distal ring member 6 of the crown spring 1 may contact the socket 58.

The crown spring 1 may be locked inside the socket 58 via friction-locking. When the crown spring 1 is inserted into the socket 58 in the axial direction 10, the ring members 4, 6 are deflected by the end section 60 of the socket 58 in the radial inward direction 64. After passing the end section 60 of the socket 58, the ring members 4, 6 may expand in a radial outward direction 66. This creates a normal force between the ring members 4, 6 and the socket 58, thereby locking the crown spring 1 frictionally locked within the socket 58.

The pin contact 26 of the mating contact is inserted into the socket 58 in the axial direction 10. Specifically, the pin contact 26 is inserted in the direction of its longitudinal axis 27, which extends in the axial direction 10.

During insertion, the pin contact 26 first enters the cylinder 8 by passing an axial end 40. After passing the first of the ring members 4, 6, the pin contact 26 may come into contact with at least those of the spring blades 2 that are provided with the contact sections 24 nearest to the pin contact 26. Further insertion of the pin contact 26 will deflect these spring blades 2 in the radial outward direction 66. The radial outward direction 66 points radially away from the central axis 12 of the crown spring 1.

The exact position along the axial direction 10 where the pin contact 26 comes into contact with the spring blades 2 depends on the diameter of the pin contact 4 and the dimensioning of the crown spring 1. Next, the pin contact 26 comes into contact with the contact sections 24 that are arranged in the first of the two annular zones 30, 42, 44.

If the pin contact 26 is now inserted further, the pin contact 26 will come into contact with those spring blades 2 that feature contact sections 24 in the second of the two annular zones 30. Depending on the mounting direction of the crown spring 1, the pin contact 26 first comes into contact with the contact sections 24 that are arranged in the proximal annular zone 42, or with the contact sections 24 that are arranged in the distal annular zone 44.

When the pin contact 26 comes into contact with the contact sections 24 of the first of the two annular zones 30, 42, 44, the spring blades 2 are deflected in a radial outward direction 66. As a result, the spring blades 2 generate a contact normal force 68 directed in the radial inward direction 64. The radial inward direction 64 points radially towards the central axis 12 of the crown spring 1. The contact normal force 68 increases until the pin contact 26 has passed the contact zone 24.

The contact normal force 68 acts on the surface 70 of the pin contact 26 and creates friction between the contact sections 24 and the sheath surface 70 of the pin contact 26. The contact normal force 68 is used both to hold the pin contact 26 inside the socket 58 and to establish a proper electrical contact between the surface 70 of the pin contact 26 and the crown spring 1.

As the pin contact 26 is further inserted, it comes into contact with the contact sections 24 in the second of the two annular zones 30, 42, 44 and deflects the spring blades 2 in the radial outward direction 66. Correspondingly, these spring blades 2 generate an additional contact normal force 68. Again, the contact normal force 68—and thus the contact insertion force, which is required to push the pin contact 26 into the crown spring 1 or the socket, respectively—will increase until the pin connector has passed the second of the two annular zones 30, 42, 44.

When the pin contact 26 is fully inserted into the crown spring 1 or into the socket 58, respectively, each spring blade 2 and the contact sections 24 that are arranged in the proximal annular zone 42 and the contact sections 24 that are arranged in the distal annular zone 44 are maximally deflected in the radial outward direction 66. The crown spring 1 forms an electrical connection between the pin contact 26 and the electric connector 56.

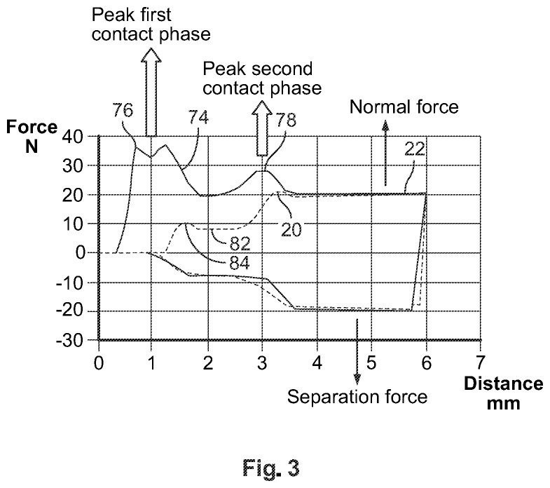

In the following, the functionality of a crown spring 1 according to another embodiment will be described with reference to FIGS. 2 and 3.

Before a pin contact 26 is inserted into a crown spring 1, the crown spring 1 may be in an initial state. Specifically, the above description with reference to FIGS. 1 and 2 may refer to the initial state. Once a pin contact 26 has been inserted into the crown spring 1, the crown spring 1 may be in a used state. In the used state, the crown spring 1 is plastically deformed as compared to the initial state. In the used state, the contact normal face and the contact insertion force show a different behavior and development upon insertion of a pin contact than in the initial state. This is explained in the following with reference to FIG. 3.

When a pin contact 26 is inserted into a crown spring 1 in the initial state, the crown spring 1 generates an initial insertion resistance force 74 in the axial direction 10. The initial insertion resistance force 74 must be overcome during insertion of the pin contact 26 into a crown spring 1.

The initial insertion resistance force 74 comprises a first initial insertion resistance force peak 76 and a second initial insertion resistance force peak 78. The first initial insertion resistance force peak 76 may be higher than the second initial insertion resistance force peak 78. The first initial insertion resistance force peak 76 is generated when the pin contact 26 gets into contact with the contact sections 24 in the first of the two annular zones 30, 42, 44. When the pin contact 26 gets into contact with the contact sections 24 in the second of the two annular zones 30, 42, 44, the second initial insertion resistance force peak 78 is generated. After contact with the contact sections 24 in the second annular zones 30, 42, 44, a final insertion resistance force 22 is generated.

When a pin contact 26 is inserted into a crown spring 1, which is in the used state, the crown spring 1 generates a constant insertion resistance force 82. The insertion resistance force 82 may be regarded as constant if it does not change by more than ±20% once the first of the two annular zones 30, 42, 44 is passed. The constant insertion resistance force 82 has a first constant insertion resistance force peak 84 when the pin contact 26 gets into contact with the contact sections 24 in the first of the two annular zones 30, 42, 44. A second constant insertion resistance force 20 arises when the pin contact 26 gets into contact with the contact sections 24 in the second of the two annular zones 30, 42, 44. After contact with the contact sections 24 in the second annular zones 30, 42, 44, in the used state, the final insertion resistance force 22 is generated.

The invention provides a crown spring 1, which is capable of reliably holding a pin in a socket and of providing a low contact resistance, and at the same time does not require a high insertion force. The insertion force of the pin contact 26 is distributed over two peaks. As a result, a higher contact normal force can be achieved. This may result in lower contact resistance and higher applicable electric current ratings. The two contact peaks also provide a haptic feedback to a user about the state of the insertion. A full insertion of the pin into the contact requires two perceptible peaks. The crown spring 1 in its initial state can be mounted inside socket more easily. In its used state, the crown spring 1 provides to a better electrical connection to the pin contact. The crown spring 1 of this embodiment therefore combines good mountability and functionality.

What is claimed is:

1. A crown spring, comprising:
a plurality of spring blades that are radially deflectable, each of the spring blades extends in an axial direction and has a proximal end and a distal end, each of the spring blades has only one contact section contacting a pin contact inserted into the crown spring in the axial direction, the contact section is disposed at a radially most inward portion of the spring blade;
a proximal ring member extending along a circumferential direction and connecting the proximal ends of the spring blades, the circumferential direction extending around the axial direction; and
a distal ring member extending along the circumferential direction and connecting the distal ends of the spring blades, the contact sections of the spring blades are arranged in a pair of annular zones that extend around the axial direction and are spaced apart from each other in the axial direction, the contact sections in each of the annular zones are located in a same radial plane perpendicular to the axial direction.

2. The crown spring of claim 1, wherein the annular zones includes a proximal annular zone and a distal annular zone, the proximal annular zone is closer to the proximal ring member in the axial direction than the distal annular zone.

3. The crown spring of claim 2, wherein a distance in the axial direction between the distal annular zone and the distal ring member corresponds to a distance in the axial direction between the proximal annular zone and the proximal ring member.

4. The crown spring of claim 3, wherein the distance in the axial direction between the distal annular zone and the distal ring member corresponds to a distance in the axial direction between the distal annular zone and the proximal annular zone.

5. The crown spring of claim 1, wherein the contact section of one of the spring blades in one of the annular zones is adjacent to two spring blades that have the contact section in the other of the annular zones.

6. The crown spring of claim 1, wherein the spring blades having contact sections in the same annular zone are formed identically.

7. The crown spring of claim 1, wherein each spring blade has a proximal straight section that extends from the proximal ring member to the contact section.

8. The crown spring of claim 7, wherein each spring blade has a distal straight section that extends from the distal ring member to the contact section.

9. The crown spring of claim 1, wherein at least one of the proximal ring member and the distal ring member has a recess.

10. The crown spring of claim 9, wherein the recess is at an axial end of the at least one of the proximal ring member and the distal ring member facing away from the spring blades.

11. The crown spring of claim 10, wherein the recess extends in the circumferential direction along less than 75% of a perimeter of the axial end.

12. The crown spring of claim 11, wherein the recess is set back in the axial direction towards the spring blades.

13. The crown spring of claim 1, wherein the contact sections in one of the annular zones are located at a same radial distance from a central axis of the crown spring that extends in the axial direction.

14. The crown spring of claim 1, wherein the contact sections of the spring blades are located at a same radial distance from a central axis of the crown spring that extends in the axial direction.

15. The crown spring of claim 1, wherein the crown spring is formed from a stamped and bent metal sheet.

16. The crown spring of claim 1, wherein the crown spring has an initial state and a used state obtained from the initial state once a pin contact has been inserted into the crown spring, the crown spring is plastically deformed in the used state.

17. The crown spring of claim 16, wherein the crown spring, in the initial state, generates a pair of successive insertion peak forces upon insertion of the pin contact.

18. The crown spring of claim 17, wherein the crown spring, in the used state, generates a constant insertion resistance force upon insertion of the pin contact.

19. An electric connector, comprising:
the crown spring according to claim 1.

20. The electric connector of claim 19, further comprising a socket, the crown spring is inserted into the socket.
